(19) United States
(12) Patent Application Publication
(10) Pub. No.: US 2026/0330171 A1
(43) Pub. Date: Oct. 22, 2026

(54) Electronic Tag Circuit, Electronic Tag Assembly and Electronic Tag Device

(71) Applicant: Tyco Electronics Holdings (Bermuda) No. 7 Limited, Hamilton (BM)

(72) Inventor: Simon Tseng, Taipei (TW)

(73) Assignee: Tyco Electronics Holdings (Bermuda) No. 7 Limited, Hamilton (BM)

(21) Appl. No.: 19/649,317

(22) Filed: Apr. 16, 2026

(30) Foreign Application Priority Data
Apr. 18, 2025 (CN) 202510497592.0
Jun. 9, 2025 (CN) 202510764311.3

(51) Int. Cl. G06K 19/07

(52) U.S. Cl. CPC G06K 19/0723

(57) ABSTRACT

An electronic tag circuit includes a first circuit and a second circuit. The first circuit includes a first coil having a number of turns being equal to n and a first inductance value. The second circuit has a total capacitance value and is connected in parallel with the first circuit to form an oscillation circuit. The second circuit includes a tag chip having a first capacitance value. The first coil exhibits a short-circuit connection for a direct current at both ends thereof when measured with an ohmmeter in a non-operating condition. The first coil, in an operating condition where an alternating current is induced, responds to a change in at least one of the first inductance value and the total capacitance value, such that each of a center frequency and a Q value of the oscillation circuit is adjustable.

### CROSS-REFERENCE TO RELATED APPLICATIONS

This application claims the benefit of the filing dates under 35 U.S.C. § 119 (a)-(d) of Chinese Patent Application Nos. 202510497592.0, filed on Apr. 18, 2025, and 202510764311.3 filed on Jun. 9, 2025.

### FIELD OF THE INVENTION

The present invention generally relates to the technical field of electronic tag technology based on wireless radio frequency electromagnetic induction and, more particularly, to an electronic tag circuit, an electronic tag assembly, and an electronic tag device, and more specifically, to an electronic tag circuit, an electronic tag assembly, and an electronic tag device based on, for example, wireless radio frequency electromagnetic induction technologies, for example, NFC or RFID.

### BACKGROUND OF THE INVENTION

Electronic tags are also referred to as radio frequency tags, transponders, data carriers; and readers are also referred to as readout devices, scanners, reading heads, communicators, reader/writers (depending on whether data can be wirelessly rewritten on the electronic tag). An electronic tag is typically a tag designed using wireless radio frequency electromagnetic induction technologies such as NFC (Near Field Communication) or RFID (Radio Frequency Identification) (note that NFC and RFID, for example, commonly operate at a frequency of 13.56 MHz), which can be fixed to a target object and can be identified and wirelessly read/written by electronic instruments, generally comprising an electronic tag chip and an antenna. For a passive electronic tag chip, it is powered and communicates, for example, by receiving a spatial electromagnetic energy field (e.g., from a transmitting coil of an electronic tag reader/writer) via an antenna (e.g., a receiving coil). It includes therein an encoding module, a decoding module, and a storage module. Coupling between the electronic tag and the reader/writer is achieved through coupling elements enabling spatial (non-contact) coupling of RF signals; within the coupling channel, energy transfer and data exchange are realized according to timing relationships.

Electronic tags typically require customization as needed, particularly customization of the coil portion of their antenna, and are added to the electronic tag chip. As an example, the number of turns of the antenna coil needs to be pre-customized, and the operating frequency is pre-set to approximately 13.56 MHz, which is generally not adjustable after the overall device is manufactured. Furthermore, if FPC and coils are over-molded, they become too soft and are prone to deformation after overall encapsulation (e.g., overmolding), failing to meet IPX67 waterproof rating and medical-grade design requirements.

Therefore, there is an urgent need in this field for an improved electronic tag circuit, electronic tag assembly, and electronic tag device based on wireless radio frequency electromagnetic induction technologies such as NFC or RFID, which utilize adjustment of circuit parameters and layout to achieve adjustable operating frequency and quality factor Q value, and overmolding of which can meet high-level sealing and small-size requirements, and the antenna coil is not easily deformed.

### SUMMARY OF THE INVENTION

An electronic tag circuit includes a first circuit and a second circuit. The first circuit includes a first coil having a number of turns being equal to n and a first inductance value. The second circuit has a total capacitance value and is connected in parallel with the first circuit to form an oscillation circuit. The second circuit includes a tag chip having a first capacitance value. The first coil exhibits a short-circuit connection for a direct current at both ends thereof when measured with an ohmmeter in a non-operating condition. The first coil, in an operating condition where an alternating current is induced, responds to a change in at least one of the first inductance value and the total capacitance value, such that each of a center frequency and a Q value of the oscillation circuit is adjustable.

### BRIEF DESCRIPTION OF DRAWINGS

The invention will now be described by way of example with reference to the accompanying figures, of which:

FIG. 1 is a schematic view of an electronic tag circuit according to an exemplary embodiment;

FIG. 2 is a bottom side perspective view of an electronic tag assembly including the electronic tag circuit of FIG. 1;

FIG. 3 is a schematic view of an electronic tag device according to an exemplary embodiment;

FIG. 4 is a layer-by-layer exploded schematic view of a circuit structure connected to a reader/writer in a reader/writer module in the electronic tag device of FIG. 3 from a top view angle, where parts other than the coil of the reader/writer module are indicated by block diagrams and schematic connecting lines; and

FIG. 5 is a schematic view of a circuit diagram of an electrical connection between the reader/writer of FIG. 4 and a second coil in the reader/writer module of FIG. 4.

### DETAILED DESCRIPTION

The present disclosure will now be described in detail with reference to the accompanying drawings, which are provided as illustrative examples of the present disclosure to enable those skilled in the art to practice the present disclosure. It is to be noted that the following drawings and examples are not intended to limit the scope of the present disclosure to a single embodiment, but rather other embodiments are possible by interchange of some or all of the described or illustrated elements. Moreover, in instances where known components may be used to implement certain elements of the present disclosure partially or entirely, only those portions of such known components necessary for understanding the present disclosure will be described, and detailed descriptions of other portions of such known components will be omitted so as not to obscure the present disclosure. Unless otherwise specified herein, embodiments described as being implemented in software, as will be understood by those skilled in the art, should not be limited as such, but may include embodiments implemented in hardware or a combination of software and hardware, and vice versa. In this specification, embodiments showing a singular component should not be considered limiting; rather, unless expressly stated otherwise herein, the present disclosure is intended to cover other embodiments including a plurality of the same components, and vice versa. Furthermore, the applicant does not intend for any term in this specification or the claims to be ascribed an uncommon or special meaning unless explicitly set forth as such. In addition, the present disclosure encompasses presently and future known equivalents of the known components referred to herein by way of illustration.

Unless otherwise specified, “bottom” and “top”, “upper” and “lower”, etc., appearing in the content recorded in the present disclosure are relative concepts. And “corresponding” or “respective” appearing in the content recorded in the present disclosure refers to the correspondence between components that are used in pairs and work cooperatively.

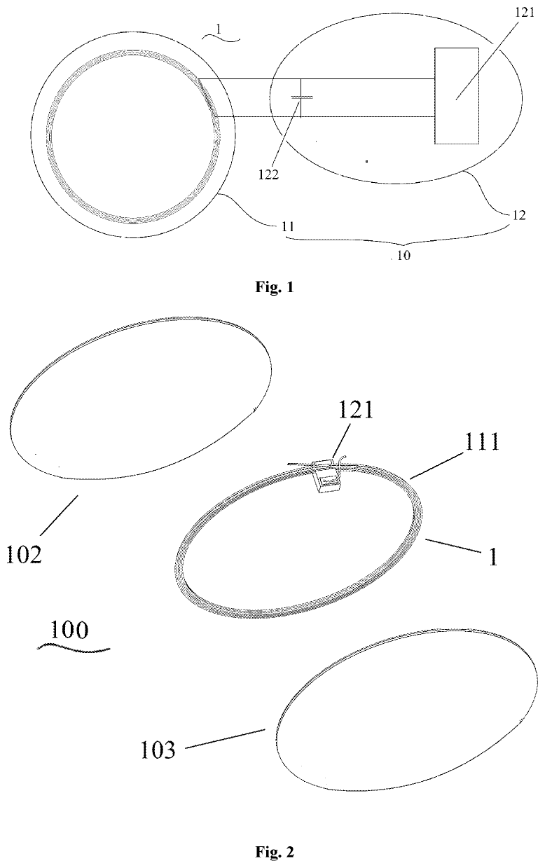

An exemplary embodiment of an electronic tag circuit 1 will now be described with reference to FIGS. 1-4. The electronic tag circuit 1 comprises a first circuit 11, as shown in FIG. 1, for example acting as an inductive circuit, comprising a first coil 111, as shown in FIG. 2, having a number of turns being equal to n (n being a positive integer greater than or equal to 1) and a first inductance value L1; and a second circuit 12, as shown in FIG. 1, for example acting as a capacitive circuit, having a total capacitance value C0 and connected in parallel with the first circuit 11 to form an oscillation circuit 10 (for example, equivalent to an LC oscillation circuit 10), as shown in FIG. 1. The second circuit 12 including a tag chip 121 (for example, a passive NFC tag or a passive RFID tag, to receive external power supply via electromagnetic induction), as shown in FIGS. 1-3, having a first capacitance value C1, whereby the total capacitance value C0 at least includes the first capacitance value C1. The first coil 111 presents a short-circuit connection for direct current at both ends thereof when measured with an ohmmeter in a non-operating condition (thus ensuring a non-open state, the center frequency does not deviate excessively from the expectation and coupling with load and effective sensing can be achieved); and the first coil 111, in an operating condition where an alternating current is induced, responds to changes in at least one of the first inductance value L1 and the total capacitance value C0, such that each of a center frequency and a Q value of the oscillation circuit 10 is adjustable.

Based on this configuration, in which the first coil 111 presents a short-circuit connection for direct current at both ends thereof when measured with an ohmmeter in a non-operating condition means: on one hand, regarding the DC characteristic of the first coil 111, it appears as a “short circuit” when measured with an ohmmeter in the non-operating state, i.e., the impedance is mainly determined by the DC resistance, while the inductive reactance is zero at this time (under DC, frequency f=0, inductive reactance XL=2πfL=0), i.e., the DC resistance is extremely small (R≈0); on the other hand, regarding the AC characteristic of the first coil 111, in an AC circuit, the impedance of the coil is jointly determined by the DC resistance R and the inductive reactance XL. Since R is extremely small, the impedance is mainly dominated by the inductive reactance, i.e.: Z=\sqrt{R²+(ωL²)}≈ωL (when R<<ωL). The inductive reactance increases linearly with frequency f (XL∂f), therefore the coil presents a larger hindering effect to high-frequency alternating current, i.e., the inductive reactance is significant (XL=ωL), and the impedance appears to be dominated by the inductive reactance and increases with rising frequency. Thus, the main electrical characteristics of the first coil 111 can be summarized as the first coil 111 having high coil inductance (i.e., a large L value) and extremely low DC resistance (R≈0). In short, this coil is short-circuited under DC due to extremely small resistance, and exhibits significant inductive reactance under AC due to its inductive characteristic.

Moreover, based on this configuration, it is convenient to fix a first one of the capacitance value and the inductance value and adjust the other, second one, and then to switch to fixing the other, second one and adjusting the first one, thereby conveniently achieving coarse and fine adjustment of the center frequency.

According to an embodiment of the present disclosure, the first coil 111, serving as an antenna for the electronic tag, generates an alternating current through electromagnetic induction (i.e., an energy harvesting step), and the coil inductance of the first circuit 11 acting as the inductive circuit resonates with the capacitance of the second circuit 12 (at least the tag chip 121) acting as the capacitive circuit and connected in parallel, so as to generate a resonance frequency (the expected resonance frequency is, for example, 13.56 Mhz commonly used in NFC and RFID), then the alternating current received by the antenna is converted to direct current (i.e., an internal rectification and filtering step) via, for example, a rectifier circuit (such as a diode bridge) and filter capacitors inside the electronic tag chip 121 so as to power the chip.

Through this configuration, an improved electronic tag circuit 1 is realized, which at least utilizes adjustment of circuit parameters to achieve an adjustable operating frequency (a frequency within a limited range, e.g., ±0.5 Mhz around the expected value of 13.56 Mhz) and quality factor Q value, thereby achieving flexible frequency and Q value adjustability compared to prior art electronic tag circuits that need to be pre-customized, have pre-set operating frequencies, and cannot be adjusted after being assembled.

In a further exemplary embodiment of the present disclosure, as an example, the second circuit 12 further comprises at least one high-pass filter 122, as shown in FIG. 1, connected in parallel with the tag chip 121. The at least one high-pass filter 122 has a second capacitance value C2, with the total capacitance value C0 being equal to the sum of the first capacitance value C1 and the second capacitance value C2.

According to an embodiment of the present disclosure, as an example, the at least one high-pass filter 122 additionally provided in the second circuit 12 (for example, the overall equivalent second capacitance value C2 thereof is variable by increasing/decreasing the number of parallel high-pass filters 122 or selecting the capacitance value of a single high-pass filter 122) is connected in parallel with the tag chip 121 (which has a fixed first capacitance value C1), then the total capacitance value C0 of the second circuit 12 equals the sum of the fixed first capacitance value C1 of the tag chip 121 and the variable overall equivalent second capacitance value C2 of the at least one high-pass filter 122 (which equals the sum of the capacitance values of all parallel high-pass filters 122), thereby achieving an adjustable total capacitance value C0 for the electronic tag circuit 1.

Based on the understanding of characteristics of the LC oscillation circuit 10, the resonance frequency is

$$f = \frac{1}{2 π \sqrt{LC}} .$$

Then the resonance frequency is inversely proportional to the square root of the total inductance value L and the square root of the total capacitance value C0.

And the quality factor Q value is

$$Q = \frac{1}{R} \sqrt{\frac{L}{C}} ,$$

then the Q value is directly proportional to the square root of the total inductance value L and inversely proportional to the square root of the total capacitance value C0.

According to an embodiment of the present disclosure, as an example, the center frequency is expected to be, for example, 13.56 Mhz, which can be used for NFC or RFID but is not limited thereto.

And according to an embodiment of the present disclosure, as an example, based on the requirements of the application scenario, the first coil 111 is wound to have a specific inner diameter dimension. As a more specific example, the overall inner diameter of the first coil 111 winding is, for example, limited to a range between 9 mm and 15 mm (preferably, for example, 11.8 mm) according to the application scenario, thereby calculating the required wire diameter of the first coil 111 and its winding inner diameter, for example, the wire diameter is preferably from 0.07 mm to 0.5 mm, such as used in an electronic tag (e.g., NFC tag) circuit employed in an electric toothbrush head, but not limited thereto, and may also be, for example, in other scenarios such as an electronic tag (e.g., NFC or RFID tag) circuit employed in a mobile electronic device.

In other words, in response to the center frequency being expected to be 13.56 MHz and the first coil 111 being wound based on the application scenario to have an inner diameter within a range between 9 mm and 15 mm, a preferred value being, for example, 11.8 mm, i.e., the inner diameter range is approximately 11.8 mm+2 mm, then correspondingly the wire diameter range of the first coil 111 capable of conveniently inducing the first coil 111 is, for example, determined to be between 0.07 mm and 0.5 mm.

Thus, according to an embodiment of the present disclosure, as an example, based on the upper and lower thresholds of the distance between the first coil 111 at the tag chip 121 (for example, a passive NFC tag or a passive RFID tag, to receive external power supply via electromagnetic induction) and the reader/writer 21 for the tag chip 121, which interacts with the first coil 111 to induce an alternating current in the first coil 111 (to power the tag chip 121) (so that the two coils can interact effectively and do not require overly precise alignment), and correspondingly (for example, through actual measurement, such as using an impedance analyzer or network analyzer), an acceptable range of the Q value is obtained, for example, between 25 and 32.

In other words, in response to the center frequency being expected to be 13.56 MHz and the first coil 111 being wound based on the application scenario to have an inner diameter limited within a range between 9 mm and 15 mm (preferably, for example, an inner diameter of 11.8 mm), the acceptable range of the Q value capable of conveniently inducing the first coil 111 is determined through measurement by, for example, a network analyzer to be between 25 and 32.

According to an embodiment of the present disclosure, as an example, in the case where the aforementioned first coil 111 is fixedly wound to have an inner diameter of a specific value within the winding inner diameter range between 9 mm and 15 mm, correspondingly, different values of the wire diameter of the first coil 111 correspond to different numbers of turns of the first coil 111. As an example, for example, in the case where the wire diameter is 0.07 mm, the number of turns required for winding the first coil 111 is, for example, 13 turns to 14 turns; additionally, for example, in the case where the wire diameter is 0.5 mm, the number of turns required for winding the first coil 111 is, for example, 6 turns to 8 turns.

According to an embodiment of the present disclosure, as an example, in a case where the first circuit 11 and the second circuit 12 are electrically connected but not yet integrally encapsulated, a single one of the first inductance value L1 of the first circuit 11 and the total capacitance value C0 of the second circuit 12 is alternately subjected to adjustment at least once, respectively, to sequentially coarse-tune and fine-tune the center frequency to be substantially 13.56 MHz. In other words, one of the first inductance value L1 of the first circuit 11 and the total capacitance value C Oof the second circuit 12 is fixed, and the other one is adjusted; and then, the other one is fixed and the one is adjusted, thereby achieving sequential coarse and fine tuning of the center frequency to the expected value of substantially 13.56 MHz.

Thus, according to an embodiment of the present disclosure, as an example, considering the adjustment of the resonance frequency, for the aforementioned specific type of electronic tag circuit 1 of the present disclosure, adjustment of inductance is typically performed to varying degrees by adjusting the number of coil turns or the tightness of each turn (the tighter each turn is wound, the shorter the overall length of the unwound inductance is; the looser the winding is, the longer the overall effective length of the unwound inductance is), while adjustment of capacitance is performed by adjusting the at least one high-pass filter 122 with adjustable capacitance value (i.e., adjusting the equivalent capacitance value of the at least one high-pass filter 122 as a whole, i.e., the second capacitance value C2) (the capacitance value of the tag chip 121 itself is the fixed first capacitance value C1).

Moreover, considering the assembling sequence of inductive devices and capacitive devices in the circuit, it is usually necessary to first place and assemble the first circuit 11, e.g., the coil winding, into position, then sequentially install the second circuit 12, and finally perform overmolding to form the encapsulation.

Thus, in an exemplary embodiment of the present disclosure, to achieve an adjustable resonance frequency, as an example, above all, in response to the total capacitance value C0 being pre-maintained at a fixed value, the first inductance value L1 is decreased to reach an inductance threshold Lt such that the center frequency shifts above a predetermined frequency, thereby achieving coarse adjustment of the resonance frequency.

As a further specific example, for instance, the first inductance value L1 of the first coil 111 is decreased by utilizing a reduction in the number of turns (the coil's inductance and internal resistance will increase and decrease with the increase and decrease of the number of turns) and/or adjusting the pre-tensioning degree of each turn. In other words, the first inductance value L1 is decreased by utilizing a reduction in the number of turns and/or tightening a pre-tensioning degree of each turn. Among others, more specifically, adjustment of the total number of turns has a greater impact on the first inductance value L1 compared to the tightening/loosening degree of each turn, thus the number of turns is adjusted first, combined with the pre-calculated capacitance value to estimate the center frequency, then the tightening/loosening degree adjustment of each turn is performed. Thereby, adjustment of the first inductance value L1 is utilized to coarsely adjust the resonance frequency.

In other words, through this configuration, under the premise that the total capacitance value C0 (i.e., the sum of the fixed first capacitance value C1 of the tag chip 121 and the overall equivalent second capacitance value C2 of the high-pass filter(s) 122) remains unchanged, if the inductance becomes smaller, the resonance frequency shifts above the predetermined frequency (e.g., the expected resonance frequency of 13.56 MHz).

After adjusting the coil's inductance to readiness, i.e., after the adjustment of the coil's inductance is completed, the first circuit 11, e.g., the coil winding, can be placed and assembled into position, for example, held by a support member described below to maintain the annular shape and pre-tensioning degree of the coil. Then, adjustment of the capacitance value of the second circuit 12 can be performed to achieve further fine adjustment of the resonance frequency.

Further, in an exemplary embodiment of the present disclosure, in response to the first inductance value L1 reaching and being maintained at the inductance threshold Lt, the total capacitance value C0 is increased to reach a capacitance threshold Ct such that the center frequency shifts down to the predetermined frequency.

As a further specific example, for instance, the total capacitance value C0 is increased by selecting each high-pass filter 122 having a larger individual capacitance value or by increasing the number of parallel high-pass filters 122. Among these, more specifically, the number of parallel high-pass filters 122 has a greater impact on the overall equivalent second capacitance value C2 of all high-pass filters 122 compared to selecting the individual capacitance value for each high-pass filter 122, thus the number of parallel high-pass filters 122 is adjusted first, combined with the adjusted and fixed first inductance value L1 to further calculate the center frequency, or combined with a network analyzer to actually measure the center frequency, then adjustment of selecting the individual capacitance value for each high-pass filter 122 is performed (for example, by replacing a single high-pass filter 122 with a different specific capacitance value), and, for example, combined with a network analyzer in real time to actually measure the center frequency, and, for example, this capacitance adjustment step can preferably be repeated iteratively. Thereby, adjustment of the second capacitance value C2 (and thus adjustment of the total capacitance value C0) is utilized to finely adjust the resonance frequency.

In other words, further through this configuration, when the first inductance value L1 of the first coil 111 has been adjusted for ready and is fixed and unchanged, if the overall equivalent second capacitance value C2 of the high-pass filter(s) 122 becomes larger, then the total capacitance value C0 (i.e., the sum of the fixed first capacitance value C1 of the tag chip 121 and the overall equivalent second capacitance value C2 of the high-pass filter(s) 122) also becomes larger accordingly, then the resonance frequency shifts in the decreasing direction until it reaches a value within the expected tolerance range near the predetermined frequency (e.g., the expected resonance frequency of 13.56 MHz).

And, the expected circuit quality factor Q value needs to fall within the range of 25 to 32, and the higher the Q value is, the better the circuit performance is, preferably, for example, 30.

In an exemplary embodiment of the present disclosure, as an example, in response to the total capacitance value C0 being maintained at a fixed value, the Q value of the oscillation circuit 10 will increase or decrease in the same trend as the increase or decrease of the first inductance value L1.

And, in another exemplary embodiment of the present disclosure, as an example, in response to the first inductance value L1 being maintained at a fixed value, the Q value of the oscillation circuit 10 will increase or decrease in the opposite trend as the increase or decrease of the total capacitance value C0.

According to the calculation equation for the circuit quality factor Q value in such an oscillation circuit 10 discussed above, it is known that the Q value is directly proportional to the square root of the total inductance value L and inversely proportional to the square root of the total capacitance value C0.

Thus, with the aid of the aforementioned configuration, once the steps of first fixing the capacitance and only adjusting the inductance as described earlier, and subsequently fixing the adjusted and ready inductance and only adjusting the variable capacitance of the high-pass filter(s) 122 are adopted, then in the case where the total capacitance value C0 is pre-maintained at a fixed value, if, during the process of decreasing the first inductance value L1, the first inductance value L1 decreases to a smaller extent, the Q value will correspondingly decrease, and conversely, if the first inductance value L1 is larger, the Q value is larger. That is, the Q value will exhibit the same increasing or decreasing trend as the increase or decrease of the first inductance value L1. And, in the case where the first inductance value L1 has been adjusted for ready and fixed and no longer changed, if, during the process of increasing the overall equivalent second capacitance value C2 of the high-pass filter(s) 122, the second capacitance value C2 increases to a higher extent, the Q value will correspondingly decrease, and conversely, if the second capacitance value C2 is smaller, the Q value is larger. Therefore, from the perspective of Q value optimization, whether in the step of first fixing the capacitance and only adjusting the inductance, or in the subsequent step of fixing the adjusted and ready inductance and only adjusting the variable capacitance of the high-pass filter(s) 122, it is necessary to consider avoiding excessive reduction of inductance or excessive increase in capacitance of the high-pass filter 122, in order to compromise between avoiding excessive degradation of the circuit quality factor Q value and performing parameter adjustment of inductance and capacitance to obtain a resonance frequency as close as possible to the expected one, so that the Q value falls within the required range, e.g., a value of 25 to 32.

After performing actual measurement and circuit performance verification with a network analyzer during the circuit parameter adjustment process, then, for example, for a coil with a wire diameter of 0.07 mm, an overall coil inner diameter of 11.8 mm, and a preferred number of coil turns of 13 to 14 turns, the resonance frequency is, for example, around 14 MHz or 13 MHz near the expected resonance frequency of 13.56 MHz.

In an alternative exemplary embodiment of the present disclosure, as an example, a different adjustment sequence for the inductance and capacitance parameters of the electronic tag circuit 1 may also be considered.

In an exemplary embodiment of the present disclosure, in order to achieve an adjustable resonance frequency, as an example, above all, based on the number of turns calculated for the expected resonance frequency, e.g., 13.56 MHz, the number of turns and the tightness of each turn of the first coil 111 is kept unchanged initially; that is, in response to the first inductance value L1 being pre-maintained at a fixed value, the total capacitance value C0 is increased to reach a capacitance threshold Ct such that the center frequency shifts below the predetermined frequency.

As a further specific example, for instance, the total capacitance value C0 is increased by selecting each high-pass filter 122 having a larger individual capacitance value or by increasing the number of parallel high-pass filters 122, for example, to cause the center frequency to shift below the predetermined frequency, thereby achieving coarse adjustment of the resonance frequency. For example, for a coil with a wire diameter of 0.07 mm, an overall coil inner diameter of 11.8 mm, and a number of coil turns of 13 to 14 turns, the resonance frequency is, for example, around 13 MHz near the expected resonance frequency of 13.56 MHz. Thereby coarse adjustment of the resonance frequency can be achieved by adjustment of the second capacitance value C2.

Further, in an exemplary embodiment of the present disclosure, the capacitance value is kept for ready and unchanged; that is, in response to the first inductance value L1 being maintained as a fixed value exceeding the inductance threshold Lt, the first inductance value L1 is decreased to reach the inductance threshold Lt such that the center frequency shifts up to the predetermined frequency, for example, within a range of +/−0.5 MHz around the expected resonance frequency of 13.56 MHz.

As a further specific example, for instance, the first inductance value L1 is decreased by utilizing a reduction in the number of turns and/or adjusting (e.g., tightening) the tightening degree of each turn. And, for example, combined with a network analyzer in real time to actually measure the center frequency, for example, this inductance adjustment step can preferably be repeated iteratively. Thereby fine adjustment of the resonance frequency can be achieved by adjustment of the first inductance value L1.

Additionally, in an exemplary embodiment of the present disclosure, as an example, the first coil 111 is held at a bottom thereof and at a radially inner side thereof by a dielectric material.

Through this configuration, for example, when the inductance and capacitance parameters have been adjusted for ready but the electronic tag circuit 1 has not yet been encapsulated via overmolding, and typically, for example, for an antenna coil with a wire diameter of 0.07 mm and an overall inner diameter of 11.8 mm, the number of coil turns has been set, for example, to 13 to 14 turns, and the obtained resonance center frequency has been verified using a network analyzer to meet the frequency tolerance requirement, and typically, for example, shifted toward a higher frequency, such as around 14 MHz. Further, considering that before encapsulation via overmolding is performed, the dielectric material surrounding the coil is air, and that after performing overmolding for the electronic tag circuit 1, particularly after encapsulating the first coil 111, the dielectric material used for overmolding and in close contact with the coil adds a dielectric material with a higher dielectric constant than air (e.g., a dielectric constant of 2 to 3), then correspondingly, the obtained resonance center frequency will decrease accordingly, and for example, will decrease from around 14 MHz by about 0.5 MHz to about 13.56 MHz. This further facilitates fine adjustment of the resonance frequency toward the expected frequency of 13.56 MHz.

And, in an exemplary embodiment of the present disclosure, as an example, the electronic tag circuit 1 further comprises: a tag-side ferrite layer disposed on a side of the electronic tag circuit 1 facing away from the first coil 111, the tag-side ferrite layer being configured to isolate the first coil 111 from being interfered and increase electric field strength.

In a more specific embodiment, for example, the tag-side ferrite layer is disposed on a side facing away from the second coil 22 which is disposed on the reader/writer 21 side and performs electromagnetic induction with the first coil 111, for example, on the top side of the first coil 111. Through this configuration, isolation of interference and enhancement of electric field strength are conveniently achieved at the tag side serving as the receiving end.

An exemplary embodiment of an electronic tag assembly 100 will now be described with reference to FIGS. 1-4. As shown in FIG. 2, the electronic tag assembly 100 comprises: the aforementioned electronic tag circuit 1; a carrier member 102 that carries the electronic tag circuit 1; and a cover member 103 that cooperates with the carrier member 102 to jointly enclose (i.e., jointly define a space for accommodating and sealing) the electronic tag circuit 1 in a waterproof encapsulation.

Through this configuration, an improved electronic tag encapsulation assembly is realized, which can achieve convenient assembly, and this two-part cooperating overmolding can meet high-level sealing and small size requirements, and the antenna coil will not be easily deformed.

Moreover, considering that the electronic tag assembly 100 provided by this other aspect of the present disclosure includes the aforementioned electronic tag circuit 1, it thus also possesses the advantages of the aforementioned electronic tag circuit 1, which will not be reiterated here.

In a further exemplary embodiment of the present disclosure, by way of example, the carrier member 102 comprises: a support platform, comprising a section having an inner side edge which is at least a portion of a circular arc segment, for example, shaped as at least a portion of a circular arc segment, and more preferably, for example, shaped as a complete annular ring or a partial annular ring; and an inner circumferential wall, protruding vertically from a radially inner side of the inner side edge, which is shaped as at least a portion of a circular arc segment, of the support platform.

In a specific exemplary embodiment, as shown by way of example, the carrier member 102 and the cover member 103 are made of a dielectric material; and the first coil 111 is supported at a bottom thereof by the support platform and is at least partially held at a radially inner side thereof by the inner circumferential wall.

Through this configuration, it can be achieved that, for example, when the inductance and capacitance parameters have been adjusted for ready but the electronic tag circuit 1 has not yet been encapsulated via overmolding, and typically, for example, for an antenna coil with a wire diameter of 0.07 mm and an overall inner diameter of 11.8 mm, the number of coil turns has been set, for example, to 13 to 14 turns, and the obtained resonance center frequency has been verified using a network analyzer to meet the frequency tolerance requirement, typically, for example, shifted toward a higher frequency, such as around 14 MHz. Further, considering that before encapsulation via overmolding is performed, the dielectric material surrounding the coil is air, and after performing overmolding for the electronic tag circuit 1, particularly after encapsulating the first coil 111, the dielectric material used for overmolding and in close contact with the coil adds a dielectric material with a higher dielectric constant than air (e.g., a dielectric constant of 2 to 3), then correspondingly, the obtained resonance center frequency will decrease accordingly, for example, from around 14 MHz by about 0.5 MHz to about 13.56 MHz. This further facilitates fine adjustment of the resonance frequency toward the expected frequency of 13.56 MHz.

In another specific exemplary embodiment of the present disclosure, as an example, the cover member 103 comprises an annular flat top plate and an outer circumferential wall extending vertically from an outer periphery of the top plate, and the outer circumferential wall fits onto the support platform, and the inner circumferential wall fits against the top plate such that the carrier member 102 and the cover member 103 jointly define a space for accommodating and sealing the electronic tag circuit 1.

Through this configuration, assembling and effective sealing of the electronic tag circuit 1 through two-part overmolding are facilitated, which can achieve convenient assembling, and this two-part cooperating overmolding can meet high-level sealing and small size requirements, and the antenna coil is not easily deformed.

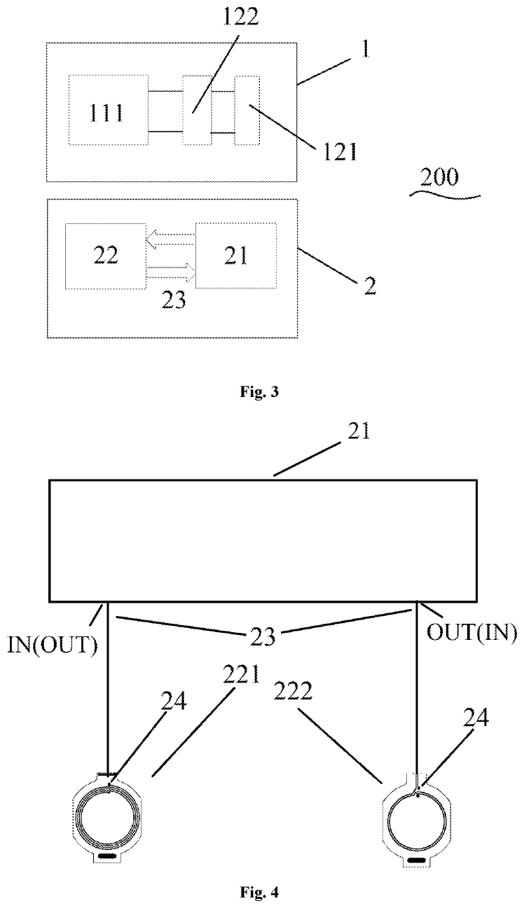

An exemplary embodiment of an electronic tag device 200 will now be described with reference to FIGS. 1-4. As shown in FIG. 3, the electronic tag device 200 comprises: the aforementioned electronic tag circuit 1; and a reader/writer module 2, disposed on a substrate. The reader/writer module 2 comprises a reader/writer 21, a second coil 22, and conductive bidirectional traces 23 electrically connected between the second coil 22 and the reader/writer 21. The second coil 22 includes at least two multi-turn coil portions stacked and connected in series, and configured to be in inductive coupling with the first coil 111 to achieve power supply to the first coil 111 and bidirectional communication therebetween. The reader/writer 21 is configured to read first information from the tag chip 121 and write second information to the tag chip 121 via the inductive coupling between the second coil 22 and the first coil 111.

As a specific example, bidirectional transfer of information with the tag chip 121 is accomplished by modulating the magnetic field (downlink) and load modulation (uplink).

And, as a specific example, the conductive bidirectional traces 23 comprise: a first trace 23, connected between an output terminal of the reader/writer 21 and an input terminal of the second coil 22; a second trace 23, connected between an input terminal of the reader/writer 21 and an output terminal of the second coil 22.

Through this configuration, it is facilitated to realize that the electronic tag reader/writer 21, for example via the second coil 22 there (comprising, for example, double-layer or multi-layer multi-turn coil portions stacked and series-connected), performs electromagnetic induction with the first coil 111 at the tag side serving as the receiving end, to promote achieving power supply and read/write operations to the electronic tag chip 121.

Moreover, considering that the electronic tag device 200 provided by this yet another aspect of the present disclosure includes the aforementioned electronic tag circuit 1, it thus also possesses the advantages of the aforementioned electronic tag circuit 1, which will not be reiterated here.

FIG. 4 shows, from a top view angle, a schematic view of the layer-by-layer decomposition of the circuit structure, which connected to the reader/writer 21, of the reader/writer module 2 in the electronic tag device 200 as shown in FIG. 3, wherein parts other than the coil of the reader/writer module 2 are indicated by block diagrams and schematic connections.

As shown in FIG. 4, in an exemplary embodiment of the present disclosure, as shown by way of example, the second coil 22 comprises at least one upper-side coil portion 221 disposed on a side of the substrate facing the first coil 111 and having a first number of turns n1, and at least one lower-side coil portion 222 disposed on another side of the substrate facing away from the first coil 111 and having a second number of turns n2. The upper-side coil portion 221 and the lower-side coil portion 222 being stacked and connected in series through vias 24 arranged therebetween. The first number of turns n1 and the second number of turns n2 are less than or equal to a maximum number of turns accommodatable on a single side of the substrate, and are interchangeable. In other words, as an example, the total number of turns of the second coil 22 is equal to the sum of the first number of turns n1 and the second number of turns n2. In a more specific example, for instance, the total number of turns of the second coil 22 is 5 turns to 8 turns, and is allocated in different combinations of the first number of turns n1 and the second number of turns n2, i.e., divided and allocated into the first number of turns and the second number of turns as needed.

In a further exemplary embodiment of the present disclosure, as shown by way of example, two ends of one coil portion of the upper-side coil portion 221 and the lower-side coil portion 222 are respectively conductively connected to two traces 23 among the bidirectional traces 23; and the other two ends of the other coil portion of the upper-side coil portion 221 and the lower-side coil portion 222 are respectively connected in series to the one coil portion connected to the bidirectional traces 23.

As a typical example, in the case of the first coil 111 described earlier, in order to effectively perform electromagnetic induction with the first coil 111, for the second coil 22 on the reader/writer 21 side, the second coil 22 needs to be tuned to a frequency of 13.56 MHz, for which the expected number of turns is 5 to 8 turns, and correspondingly, the actual total resistance value is approximately between 3 ohms and 10 ohms, preferably 7.3 ohms, and the total inductance value L is approximately between 1 μH and 2 μH, preferably 1.63 μH. In other words, the total resistance value and the total inductance value L of the reader/writer module 2 are selected to satisfy at least one of the following: the total resistance value of the reader/writer module 2 being between 3 ohms and 10 ohms, preferably 7.3 ohms; the total inductance value L of the reader/writer module 2 being between 1 μH and 2 μH, preferably 1.63 μH. However, regarding the installation space at the second coil 22, as an example, at most, for example, no more than 4 turns of coil can be placed on a single side, resulting in a limitation on the number of installable turns on a single side to be overcome.

Thus, through this configuration, it is convenient, under the size constraint that only a limited number of coil turns can be accommodated on a single side, to increase the total number of turns of the second coil 22 that can be accommodated on the reader/writer 21 side by arranging multi-turn coils on opposite sides in an overlapping configuration (double-layer stacking, i.e., front and back sides), or alternatively multi-layer stacking, with corresponding turns of coils on each side being connected via vias 24, and corresponding turns of coils on each layer being connected via vias 24 and/or jump wires. And the specific first number of turns n1 and second number of turns n2 arranged on, for example, two opposite sides can be interchanged. As an example, for instance, it could be a configuration where one side has 2 turns and the other side has 4 turns, connected via vias 24 in an overlapping but series-connected arrangement, with the total number of turns falling within the desired range of 5 to 8 turns. Alternatively, it could be a configuration where one side has 4 turns and the other side has 2 turns, connected via vias 24 in an overlapping but series-connected arrangement. Of course, other combinations of turns and front/back side arrangements are also possible, as long as calculations and/or actual measurement results from a network analyzer meet the requirements.

In an exemplary embodiment of the present disclosure, as an example, in a critical state where the first coil 111 is capable of providing a signal feedback, i.e., returning a signal to the second coil 22, in response to electrical power transmitted by the reader/writer module 2 via the second coil 22, a distance between the first coil 111 and the second coil 22 is defined as an effective transmission distance Le, and the effective transmission distance Le exhibits a reverse trend of change where it increases with a decrease in the internal resistance of the bidirectional traces 23 (i.e., the sum of the internal resistances of the bidirectional traces 23 respectively connected to the stacked coil portions) and it decreases with an increase in the internal resistance of the bidirectional traces 23. In other words, in a condition that, after the reader/writer 21 sends power, via the coupling between the second coil 22 and the first coil 111, to the electronic tag chip 121 to achieve power supply, the tag chip 121 is in turn capable of providing signal feedback, then, the distance between the first coil 111 and the second coil 22 changes reversely as compared with a change in the total internal resistance of the bidirectional trace 23.

In an exemplary embodiment of the present disclosure, as an example, the electronic tag device 200 further comprises: a reader/writer-side ferrite layer disposed on a side of the substrate facing away from both the first coil 111 and the second coil 22, the reader/writer-side ferrite layer being configured to isolate interference from a metal casing for the reader/writer module 2.

In a more specific embodiment, for example, the tag-side ferrite layer is disposed on a side of the substrate facing away from the second coil 22 which is disposed on the electronic tag reader/writer 21 side and performs electromagnetic induction with the first coil 111, for example, on the bottom side of the second coil 22. Through this configuration, isolation of interference and enhancement of electric field strength are conveniently achieved at the side of the reader/writer 21 serving as the transmitting end.

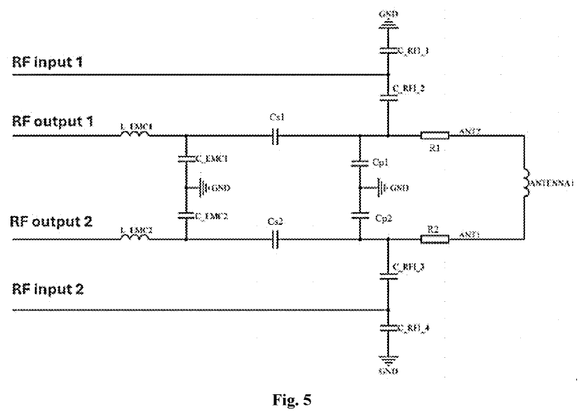

FIG. 5 shows a schematic circuit diagram of the electrical connection between the reader/writer 21 and the second coil 22 in the reader/writer module 2 as shown in FIG. 4.

In an exemplary embodiment of the present disclosure, as shown by way of example, the reader/writer module 2 further comprises a third circuit disposed between the reader/writer 21 and the second coil 22, and differential signals are utilized between the third circuit and the second coil 22 to pass through a symmetric differential amplifier circuit, an EMC filter circuit, and a parallel resonant network circuit so as to achieve balanced driving and impedance matching therebetween, and the frequency at the second coil 22 is substantially tuned to 13.56 MHz. In other words, the third circuit achieves balanced driving and impedance matching based on differential signals and being tuned to a frequency of substantially 13.56 MHz at the second coil 22.

In a further exemplary embodiment of the present disclosure, as an example, the third circuit includes the following items arranged in a cascaded configuration: an EMC filter circuit, configured to perform filtering and suppress common-mode noise; an antenna circuit, arranged to be coupled with the second coil 22 and configured to perform tuning and impedance matching for the second coil 22; and an intermediate circuit, disposed between the EMC filter circuit and the antenna circuit and constructed as a circuit exhibiting electrical characteristics of being open to a direct current and conductive to an alternating current.

Based on this configuration, in a non-operating condition of the intermediate circuit in which the intermediate circuit is measured with an ohmmeter, the intermediate circuit is open to the direct current at both ends thereof, and such a condition means: on one hand, regarding the DC characteristic, once operating as a DC circuit, the intermediate circuit (e.g., each series capacitor thereof) appears to be in an open circuit when measured with an ohmmeter in the non-operating state, i.e., being equivalent to an extremely large DC resistance (e.g., R→∞); on the other hand, regarding the AC characteristic, once operating as an AC circuit, the intermediate circuit appears to be short circuited under AC, indicating that the coil's inductive reactance is extremely small. According to the inductive reactance formula XL=2πfL, this may be caused by at least one of the following reasons: extremely small inductance (L→0): for example, very few coil turns or absence of a magnetic core, causing inductance to be almost zero; extremely low frequency (f→0): inductive reactance approaches zero under low-frequency AC (however, upon considering the expected frequency of 13.56 MHz, this point does not hold). Thus, at the location of the intermediate circuit, there exists a circuit exhibiting electrical characteristics of “blocking DC and passing AC”, i.e., being open to the direct current and conductive to the alternating current.

And as an example, as shown, for the conductive bidirectional traces 23, i.e., the first trace 23 connected between the output terminal of the reader/writer 21 and the input terminal of the second coil 22, a differential signal is applied; the second trace 23 connected between the input terminal of the reader/writer 21 and the output terminal of the second coil 22 reads feedback from the tag side.

Regarding the third circuit as shown in FIG. 5, there are a first path, i.e., the driving path, from the differential output of the reader/writer 21 to the second coil 22, and a second path, i.e., the feedback path, from the second coil feedback to the input of the reader/writer 21.

First, the first path from the differential output of the reader/writer 21 to the second coil 22, i.e., the driving path, will be discussed.

In a more specific exemplary embodiment of the present disclosure, as shown, as an example, RF output 1 and RF output 2 are the differential output terminals of the reader/writer 21. In the EMC filter circuit directly electrically connected to the two output terminals of the reader/writer 21, the two inductors L_EMC1 and L EMC2 are common-mode choke inductors, respectively connected in series to the corresponding output terminals of the reader/writer 21 to suppress common-mode noise, indirectly enhancing the transmission efficiency of the differential signal, functioning for “signal enhancement”; and the two inductors L_EMC1 and L EMC2 are respectively connected to ground via corresponding filter capacitors C_EMC1 and C_EMC2 to filter high-frequency noise, and to ground, thereby reducing signal distortion and ensuring the purity of the driving signal.

In a more specific exemplary embodiment of the present disclosure, as shown, as an example, regarding the antenna circuit arranged to be coupled with the second coil 22 and configured to perform tuning and impedance matching for the second coil 22, tuning capacitors (for example, C_RF1_1 and C_RF1_2 which are connected, and C_RF1_3 and C_RF1_4 which are also connected) cooperate with the inductance of the second coil antenna (labeled as ANTENNA1) to form parallel resonant tuning. And the tuning capacitors can, for example, serve to at least partially cancel the inductive reactance of the antenna, making the antenna to exhibit a purely resistive characteristic at the target frequency, maximizing energy transmission efficiency for impedance matching; in other words, the tuning capacitors also function to optimize impedance matching between the second coil 22 and the antenna circuit, reducing reflection loss.

And as an example, parallel capacitors Cp1 and Cp2 are connected in parallel to ground, and used to short-circuit high-frequency noise to ground to purify the signal; and each of the parallel capacitors Cp1 and Cp2 has a typical value, for example, within a range between 80 pF and 150 pF. Moreover, the parallel capacitors Cp1 and Cp2 participate in the cooperation of the tuning capacitors (such as connected C_RF1_1 and C_RF1_2, and connected C_RF1_3 and C_RF1_4) with the inductance of the second coil antenna (labeled as ANTENNA1) to form a tuning network, so as to tune the operating frequency of the antenna to the target value (such as 13.56 MHz for NFC). In other words, the parallel capacitors Cp1 and Cp2 are used to cooperate with the tuning capacitors (for example, C_RF1_1 and C_RF1_2 which are connected, and C_RF1_3 and C_RF1_4 which are also connected) respectively connected in parallel to the second coil 22 connected to the corresponding resistors R1 and R2, and with the inductance of the antenna, so as to form a parallel resonant circuit to jointly tune and determine the resonant frequency.

And as an example, herein, the resistors R1 and R2 respectively connected in series to the second coil 22 function to dampen the resonance, by cooperating with the tuning capacitors (e.g., R1 cooperates with C_RF1_1, C_RF1_2; R2 cooperates with C_RF1_3, C_RF1_4), limiting the quality factor Q of the antenna resonant circuit from being too high, preventing signal overshoot or oscillation, ensuring frequency band stability, i.e., damping the resonance peak. Additionally, the resistance values of resistors R1 and R2 are, for example, adjusted to optimize impedance matching between the antenna circuit and the driving circuit, reducing reflection loss, and improving energy transmission efficiency. Furthermore, the resistors R1 and R2 also function to limit the peak high-frequency current flowing to the antenna, protecting backend components (such as capacitors or the antenna) from instantaneous overcurrent damage, i.e., current limiting protection.

In a more specific exemplary embodiment of the present disclosure, as shown, as an example, between the EMC filter circuit and the antenna circuit, there also exists the intermediate circuit, for example, including a circuit exhibiting electrical characteristics of “blocking DC and passing AC”, i.e., being open to direct current and conductive to alternating current. Typically, this intermediate circuit, as shown, includes, for example, a high-pass filter 122. In other words, it is manifested that at the location of the intermediate circuit related to the second coil 22 (e.g., at the series capacitors, typically implemented as a high-pass filter), it is open to direct current at both ends thereof when measured with an ohmmeter in a non-operating condition. But the intermediate circuit functions as a short circuit for AC.

In the illustrated more specific example, the intermediate circuit includes a high-pass filter 122, comprising series capacitors Cs1 and Cs2 respectively connected in series to each output terminal of the reader/writer 21, and each of the series capacitors Cs1 and Cs2 has a capacitance value range similar to the aforementioned parallel capacitors Cp1 and Cp2, typically, for example, within a range between 80 pF and 150 pF. Consequently, the intermediate circuit is a high-pass filter 122, and has a capacitance value of 80 pF to 150 pF.

And, in the first path, through symmetric circuit arrangement, the amplitudes and phases of the two signals from RF Output 1 and RF Output 2 are ensured to be consistent with each other, maintaining the symmetry of the differential driving.

Next, the second path from the second coil 22 feedback to the input of the reader/writer 21, i.e., the feedback path, will be discussed.

In a more specific exemplary embodiment of the present disclosure, as shown, as an example, RF input1 and RF input2 are the differential input terminals of the reader/writer 21.

In the second path, in the antenna circuit, the second coil 22 (e.g., labeled as ANTENNA1) senses the modulation signal returned from the first coil 111 on the tag side, for example, called as load modulation, which is the signal reception process.

The signal then passes through the tuning network of the antenna circuit (C_RF1_1 and C_RF1_2, and C_RF1_3 and C_RF1_4), such that non-resonant frequency components are filtered out from the signal; wherein C_RF1_1 and C_RF1_4 are respectively connected in parallel to the ground. Thereby impedance matching is optimized and the reflection loss is reduced.

Subsequently, the processed differential signals respectively reach RF Input 1 and RF Input 2, where they are decoded by the reader/writer 21 to obtain the data fed back from the tag side.

In an exemplary embodiment of the present disclosure, as an example, the aforementioned electronic tag device 200 can be applied to, for example, different application scenarios.

In a further specific embodiment, for example, the electronic tag device 200 is applied to an electric toothbrush scenario, and the receiving-side passive electronic tag circuit 1 is disposed in a replaceable brush head, while the transmitting-side reader/writer module 2 is disposed in a brush handle. Typically, for example, the reader/writer module 2 wirelessly supplies power via electromagnetic induction to the tag chip 121 in the receiving-side electronic tag circuit 1, and reads signals from the tag chip 121, and even writes to the tag chip 121.

In another specific embodiment, for example, the electronic tag device 200 is applied to scenarios such as mobile electronic terminals such as smartphones or tablets, laptops, smart wearable devices (e.g., smartwatches, wristbands, or Head-Mounted Displays), or smart item tags. Typically, the receiving-side passive electronic tag circuit 1 is disposed in the body of such a mobile electronic terminal, while the transmitting-side reader/writer module 2 is disposed in a corresponding transmitting-side device (e.g., another mobile electronic terminal for data exchange, a payment machine in a supermarket or store, a bank smart teller machine, a scanner in the logistics or supply chain industry, an access control device, or a card reader device, a stored value machine or gate in a public transportation system). Typically, for example, the reader/writer module 2 wirelessly supplies power via electromagnetic induction to the tag chip 121 in the receiving-side electronic tag circuit 1, and reads signals from the tag chip 121, and even writes to the tag chip 121.

And as a specific example, the aforementioned electronic tag can be based on wireless radio frequency electromagnetic induction technologies such as NFC (Near Field Communication) or RFID (Radio Frequency Identification) (it should be noted that NFC and RFID, for example, typically have a common operating frequency of 13.56 MHz).

Based on the above-configured electronic tag circuit 1, the electronic tag assembly 100, and the electronic tag device 200, at least the following superior technical effects compared to existing technical solutions in the field can be achieved:

An improved electronic tag circuit 1 is realized, which at least utilizes adjustment of circuit parameters to achieve an adjustable operating frequency (a frequency within a limited range, e.g., ±0.5 Mhz around the expected value of 13.56 Mhz) and an adjustable quality factor Q value, thereby achieving flexible frequency and Q value adjustability compared to prior art electronic tag circuits that need to be pre-customized, have pre-set operating frequencies, and cannot be adjusted after assembly. Moreover, an improved electronic tag encapsulation assembly is realized, which can achieve convenient assembling, and this two-part cooperating overmolding can meet high-level sealing and small size requirements, and the antenna coil will not be easily deformed. Furthermore, an improved electronic tag device 200 is also realized, facilitating that the electronic tag reader/writer 21, for example via the second coil 22 (comprising, for example, double-layer or multi-layer stacked and series-connected multi-turn coil portions) disposed at the electronic tag reader/writer 21, performs electromagnetic induction with the first coil 111 at the side of the tag serving as the receiving end, to promote achieving of power supply and read/write operations to the electronic tag chip 121.

An exemplary embodiment of an interactive device will now be described. The interactive device comprises: a first body, a second body in a mechanical connection or electrical coupling relationship with the first body, and the aforementioned electronic tag device 200. the reader/writer module 2 is disposed in the first body, and the electronic tag circuit 1 is disposed in the second body.

The embodiments of the present disclosure aim to solve at least one aspect of the aforementioned and other problems and defects in the related art by providing a detection device which is simple in structure through a simple design of the circuit structure and a reconfiguration of the circuit and encapsulation scheme layout, thereby realizing an improved electronic tag circuit 1, electronic tag assembly 100, and electronic tag device 200 based on wireless radio frequency electromagnetic induction technologies such as NFC or RFID. The improved electronic tag circuit 1, electronic tag assembly 100, and electronic tag device 200 utilize adjustment of circuit parameters and layout to achieve adjustable operating frequency, and overmolding of them can meet high-level sealing and small-size requirements, and the antenna coil is not easily deformed. As such, an improved technical solution addressing the above-mentioned issues requiring improvement is achieved.

The foregoing descriptions of the electronic tag circuit 1, the electronic tag assembly 100, and the electronic tag device 200 in the aforementioned embodiments of the present disclosure are intended to be illustrative, not restrictive. Although the present disclosure has been described with reference to the accompanying drawings, the embodiments disclosed in the drawings are intended to exemplify preferred implementations of the present disclosure and should not be construed as a limitation of the present disclosure.

Therefore, those skilled in the art will understand that the above-described embodiments are exemplary, and those skilled in the art can make improvements thereto. The structures described in the various embodiments can be modified and freely combined without conflict in structure or principle, and such variations should fall within the protection scope of the present disclosure.

The breadth and scope of the present disclosure should not be limited by any of the above-described exemplary embodiments, but should be defined only in accordance with the following claims and their equivalents.

It should be noted that the word “comprising”, “including” does not exclude other elements or steps, and the word “a” or “an” does not exclude a plurality. Furthermore, any element reference signs in the claims should not be construed as limiting the scope of the present disclosure.

1. An electronic tag circuit, including:
a first circuit including a first coil having a number of turns being equal to n and a first inductance value; and
a second circuit having a total capacitance value and connected in parallel with the first circuit to form an oscillation circuit, the second circuit includes a tag chip having a first capacitance value, the first coil exhibits a short-circuit connection for a direct current at both ends thereof when measured with an ohmmeter in a non-operating condition, and the first coil, in an operating condition where an alternating current is induced, responds to a change in at least one of the first inductance value and the total capacitance value, such that each of a center frequency and a Q value of the oscillation circuit is adjustable.

2. The electronic tag circuit of claim 1, wherein, the second circuit has at least one high-pass filter connected in parallel with the tag chip, the at least one high-pass filter has a second capacitance value, the total capacitance value is equal to a sum of the first capacitance value and the second capacitance value.

3. The electronic tag circuit of claim 1, wherein when the first circuit and the second circuit are electrically connected but not yet integrally encapsulated, a single one of the first inductance value and the total capacitance value is alternately subjected to adjustment at least once, respectively, to sequentially coarse-tune and fine-tune the center frequency to be substantially 13.56 MHz.

4. The electronic tag circuit of claim 1, wherein, in response to the center frequency being expected to be 13.56 MHz and the first coil being wound to have an inner diameter within a range between 9 mm and 15 mm, an acceptable range of the Q value for an induction of the first coil is between 25 and 32.

5. The electronic tag circuit of claim 1, wherein in response to the center frequency being expected to be 13.56 MHz and the first coil being wound to have an inner diameter within a range between 9 mm and 15 mm, a wire diameter range of the first coil capable of inducing the first coil is between 0.07 mm and 0.5 mm.

6. The electronic tag circuit of claim 5, wherein when a wire diameter of the first coil is 0.5 mm, the number of turns of the first coil is 6 turns to 8 turns, and when the wire diameter of the first coil is 0.07 mm, the number of turns of the first coil is 13 turns to 14 turns.

7. The electronic tag circuit of claim 1, further comprising a tag-side ferrite layer disposed on a side of the electronic tag circuit facing away from the first coil, the tag-side ferrite layer isolates the first coil from being interfered and increases field strength.

8. An electronic tag assembly, comprising:
an electronic tag circuit including a first circuit and a second circuit, the first circuit includes a first coil having a number of turns being equal to n and a first inductance value, the second circuit has a total capacitance value and is connected in parallel with the first circuit to form an oscillation circuit, the second circuit includes a tag chip having a first capacitance value, the first coil exhibits a short-circuit connection for a direct current at both ends thereof when measured with an ohmmeter in a non-operating condition, and the first coil, in an operating condition where an alternating current is induced, responds to a change in at least one of the first inductance value and the total capacitance value, such that each of a center frequency and a Q value of the oscillation circuit is adjustable;
a carrier member that carries the electronic tag circuit; and
a cover member that cooperates with the carrier member to jointly enclose the electronic tag circuit in a waterproof encapsulation.

9. The electronic tag assembly of claim 8, wherein the carrier member and the cover member are each made of a dielectric material.

10. An electronic tag device, comprising:
an electronic tag circuit including a first circuit and a second circuit, the first circuit includes a first coil having a number of turns being equal to n and a first inductance value, the second circuit has a total capacitance value and is connected in parallel with the first circuit to form an oscillation circuit, the second circuit includes a tag chip having a first capacitance value, the first coil exhibits a short-circuit connection for a direct current at both ends thereof when measured with an ohmmeter in a non-operating condition, and the first coil, in an operating condition where an alternating current is induced, responds to a change in at least one of the first inductance value and the total capacitance value, such that each of a center frequency and a Q value of the oscillation circuit is adjustable; and
a reader/writer module, disposed on a substrate and including a second coil, a reader/writer, and conductive bidirectional traces electrically connected between the second coil and the reader/writer, the second coil includes at least two multi-turn coil portions stacked and connected in series, and in inductive coupling with the first coil to achieve power supply to the first coil and bidirectional communication therebetween, the reader/writer reads first information from the tag chip and writes second information to the tag chip via the inductive coupling between the second coil and the first coil.

11. The electronic tag device of claim 10, wherein the second coil includes at least one upper-side coil portion and at least one lower-side coil portion, the at least one upper-side coil portion is disposed on a side of the substrate facing the first coil and has a first number of turns, the at least one lower-side coil portion is disposed on an other side of the substrate facing away from the first coil and has a second number of turns, the upper-side coil portion and the lower-side coil portion are stacked and connected in series through vias arranged therebetween, the first number of turns and the second number of turns are less than or equal to a maximum number of turns accommodatable on a single side of the substrate, and are interchangeable.

12. The electronic tag device of claim 11, wherein a total number of turns of the second coil is equal to a sum of the first number of turns and the second number of turns.

13. The electronic tag device of claim 12, wherein the total number of turns of the second coil is 5 turns to 8 turns, and is allocated in different combinations of the first number of turns and the second number of turns.

14. The electronic tag device of claim 13, wherein a total resistance value and a total inductance value of the reader/writer module are at least one of the following: the total resistance value of the reader/writer module is between 3 ohms and 10 ohms; the total inductance value of the reader/writer module is between 1 μH and 2 μH.

15. The electronic tag device of claim 11, wherein two ends of one coil portion of the upper-side coil portion and the lower-side coil portion are respectively electrically connected to two traces of the bidirectional traces, and an other two ends of an other coil portion of the upper-side coil portion and the lower-side coil portion are respectively connected in series to the one coil portion connected to the traces.

16. The electronic tag device of claim 10, wherein in a critical state where the first coil provides a signal feedback in response to electrical power transmitted by the reader/writer module via the second coil, a distance between the first coil and the second coil is an effective transmission distance, the effective transmission distance exhibits a reverse trend of change where it increases with a decrease in an internal resistance of the traces and it decreases with an increase in the internal resistance of the traces.

17. The electronic tag device of claim 10, further comprising a reader/writer-side ferrite layer disposed on a side of the substrate facing away from both the first coil and the second coil, the reader/writer-side ferrite layer isolates interference from a metal casing for the reader/writer module.

18. The electronic tag device of claim 10, wherein the reader/writer module includes a third circuit disposed between the reader/writer and the second coil, the third circuit achieves balanced driving and impedance matching based on differential signals and is tuned to a frequency of substantially 13.56 MHz at the second coil.

19. The electronic tag device of claim 18, wherein the third circuit includes the following arranged in a cascaded configuration:
an EMC filter circuit, the EMC filter circuit performs filtering and suppresses common-mode noise;
an antenna circuit, the antenna circuit is coupled with the second coil and performs tuning and impedance matching for the second coil; and
an intermediate circuit, the intermediate circuit is disposed between the EMC filter circuit and the antenna circuit and is constructed as a circuit exhibiting electrical characteristics of being open to the direct current and conductive to the alternating current.

20. The electronic tag device of claim 19, wherein the intermediate circuit is a high-pass filter, and each capacitor thereof has a capacitance value within a range of 80 pF to 150 pF.
